(19) United States
(12) Patent Application Publication
(10) Pub. No.: US 2008/0253907 A1
(43) Pub. Date: Oct. 16, 2008

(54) Cooling of Stator for Compressor

(75) Inventor: Bjorn Lind, Goteborg (SE)

Correspondence Address: SCHWEGMAN, LUNDBERG & WOESSNER, P.A., P.O. BOX 2938, MINNEAPOLIS, MN, 55402, US

(73) Assignee: Lind Finance & Development AB, Goteborg (SE)

(21) Appl. No.: 12/066,457

(22) PCT Filed: Sep. 13, 2006
(86) PCT No.: PCT/SE06/50325

§ 371 Date: Jun. 23, 2008

(30) Foreign Application Priority Data
Sep. 15, 2005 (SE) 0502034-2

(51) Int. Cl. F04D 25/06; F04D 29/08; F04D 29/58; H02K 9/197

(52) U.S. Cl. 417/354; 417/423.11; 277/306; 310/54

(57) ABSTRACT

Compressor comprising a housing (1a, 1b) and with at least one partly electric-motor-driven impeller (3) arranged on a central shaft (5). The invention is characterized in that the impeller (3) is provided with a tubular part (6) surrounding the central shaft (5), and also in that a tubular carrier (2) extending in between the central shaft (5) and the tubular part (6) is arranged firmly on the housing, in which carrier (2) the central shaft (5) is rotatably mounted.

The present invention relates to a compressor according to the precharacterizing clause of Patent Claim 1.

Technology within the field of fuel cells generating electrical energy as an alternative to fossil fuels, as a primary energy source for vehicles for example, is aiming at more compact and more efficient units. The principle of fuel cells can be described very generally as hydrogen gas and oxygen reacting with one another via electrodes, generating electrical energy. The “exhaust gas product” in the reaction between hydrogen and oxygen is water. The oxygen required in the process is supplied in the form of great quantities of air at positive pressure.

The present invention relates to a type of compressor for producing the process air required, where the compressor is supplied with energy via on the one hand an electric motor and on the other hand recovery of at least part of the energy remaining in the process air when it has passed through the fuel cells. The requirements for the unit are on the one hand low weight and small volume, which is achieved by high speeds being used, and on the other hand high reliability and minimum maintenance, which is achieved by the unit being fluid-mounted statically and/or dynamically and by contactless seals being used. These requirements are met by the invention having been provided with the features indicated in the patent claims.

The invention will be described in greater detail in the form of an example with reference to the drawing, which shows diagrammatically a cross section through a compressor according to the invention.

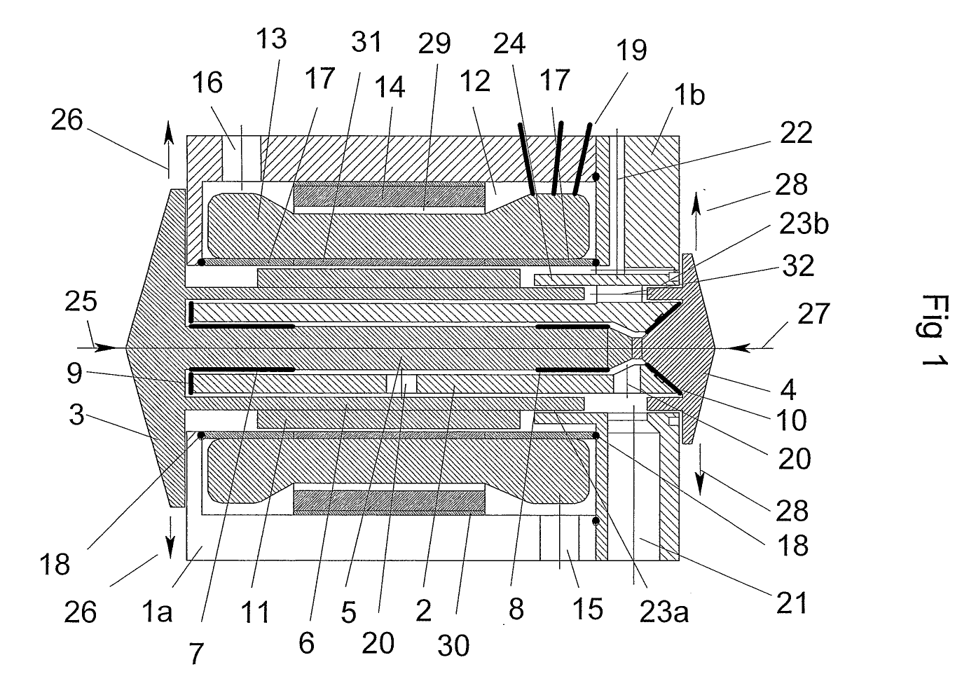

In FIGS. 1, 1a and 1b designate an essentially cylindrical housing, which has centrally a tubular carrier 2 connected to the housing 1b and open at one end. An impeller 3 and a turbine wheel 4 are interconnected by means of a common shaft 5. A tubular part 6, which surrounds at least part of the tubular carrier 2, is connected firmly to the impeller 3. The common shaft 5, bearing the impeller 3 and the turbine wheel 4, is mounted rotatably in the inner cylindrical surface—the bearing surface—of the tubular carrier by means of fluid bearings 7 and 8. 9 and 10 designate thrust bearings for supporting the shaft 5 with the impeller 3 and the turbine wheel 4 in the axial direction. These bearings are also of the fluid type.

In the drawing, 11 designates the rotor of an electric motor, which rotor is fastened to the cylindrical outside of the tubular part 6. The stator winding 13 of an electric motor is, together with its stator iron 14, received in a space 12 in the housing 1a. The parts 13, 14 of the electric motor and the housing 1a, 1b are cooled by a coolant which is introduced through an inlet 15, flows through the stator winding and the stator iron 14 via channels 29 (winding slots) and leaves the space 12 through an outlet 16. The space 12 is sealed completely in relation to the rotor 11, the tubular part 6, the tubular carrier 2 and the shaft 5 by means of the cylindrical sealing sleeves 17 arranged between the stator winding 13 and the rotor 11, which on the one hand seal in relation to the stator iron 14, the winding slots of which are sealed in relation to the rotor, and on the other hand are sealed by O rings for example in relation to the housing parts 1a and 1b.

The tubular part 6 can of course itself form the rotor of the electric motor 11.

The design of the cooling system contributes to the compact design of the compressor.

19 indicates diagrammatically electric cables and other connections to the stator parts of the motor.

The fluid bearings are fed with a bearing medium, for example water, oil, coolant or gas, from channels drilled in a suitable way leading to respective bearings (not shown in the figure). The bearing medium fed to the bearings is led off via radial openings 20 formed in the tubular carrier 2 in order to be conducted to the outlet 21. That part of the bearing medium which passes into the gap between the carrier 2 and the inside of the tubular part 6 bearing the rotor will cool the rotor 11 of the motor via the tubular part 6.

In order to prevent the bearing medium following other paths than being conducted out through the outlet 21, two gap seals 23a, 23b are provided, the gap seal 23a between a cylindrical collar 24 and the rotatable tubular part 6 and the gap seal 23b between a collar-shaped part on the turbine wheel 4 and the cylindrical part of the housing 1b. These gap seals are provided via a channel 22 which ends on the one hand inside the collar 24 and on the other hand in a groove adjacent to the turbine wheel 4, with a gas flow at a pressure higher than the pressure in the outlet 21. This gas flow can be part of the process air which is used for this purpose and will, together with the bearing medium, leave the unit via the outlet 21.

The compressor and turbine housings with inlets, guide vanes and outlets are not illustrated in the drawing, but it is understood that these function in a known manner. The arrow 25 thus indicates process air which is drawn in and fed out (indicated by arrow 26) at positive pressure to the fuel cell. In order to increase efficiency, residual process air is thus dealt with (indicated by arrows 27 and 28) by the turbine wheel, which recovers energy, which is returned to the impeller 3 in order, together with the energy supplied via the electric motor, to drive the impeller 3.

As mentioned, the space 12 is flowed through by a coolant (inlet 15, outlet 16) which cools the stator iron, the stator winding and the compressor housing 1a, 1b. In order to make cooling of the stator winding and the stator iron possible, these must be insulated against direct contact with the coolant because the coolant can be electrically conductive or corrosive. This can suitably be effected by means of a thin, heat-conducting film made of a material which is not electrically conductive and is not affected by the coolant. In order to make it possible to machine a close tolerance on the outside diameter of the stator without the stator iron being exposed, a machinable material 30, which tolerates the coolant, has been applied firmly to the outside diameter of the stator iron before the protective film is applied, whereupon the outside diameter of the stator can be machined exactly.

It is to be understood that the use of a turbine wheel is optional within the scope of the invention and that the invention is not limited to being applied only in connection with fuel cells.

1. A compressor, comprising a housing and with a partly electric-motor-driven impeller arranged on a central shaft, wherein the impeller includes a tubular part surrounding the central shaft and wherein a tubular carrier extending in between the central shaft and the tubular part is arranged firmly on the housing, in which carrier the central shaft is rotatably mounted.

2. The compressor according to claim 1, wherein the tubular part bears the rotor of the electric motor.

3. The compressor according to claim 1, wherein the tubular part completely or partly forms the rotor of the electric motor.

4. The compressor according to claim 3, wherein the central shaft is fluid-mounted in the carrier.

5. The compressor according to claim 4, wherein the stator parts of the electric motor are sealed in relation to the rotor and wherein a cooling fluid is arranged to pass around and/or through the stator parts, which have been sealed, at least in the regions where the stator parts are exposed to contact with the cooling fluid, with a heat-conducting surface coating resistant to the cooling fluid made of a material which is not electrically conductive.

6. The compressor according to claim 5, wherein the electric-motor-driven impeller includes a turbine wheel for returning energy recovered from the remaining process air to the essentially electric-motor-driven impeller.

7. A method for sealing the rotor according to claim 5, comprising applying a machinable material resistant to the coolant to the outside diameter of the stator, applying a sealing protective film, made of a material resistant to the coolant, to the stator iron and the stator winding, and wherein the machinable material of the stator iron is machined to the desired exact diameter.

8. The compressor according to claim 1, wherein the central shaft is fluid-mounted in the carrier.

9. The compressor according to claim 8, wherein the stator parts of the electric motor are sealed in relation to the rotor and wherein a cooling fluid is arranged to pass around and/or through the parts of the stator, which have been sealed, at least in the regions where the parts of the stator are exposed to contact with the cooling fluid, with a heat-conducting surface coating resistant to the cooling fluid made of a material which is not electrically conductive.

10. The compressor according to claim 9, wherein the essentially electric-motor-driven impeller is provided with a turbine wheel for returning energy recovered from the remaining process air to the essentially electric-motor-driven impeller.

11. The compressor according to claim 10, wherein the cooling fluid includes a liquid.

12. The compressor according to claim 5, wherein the cooling fluid includes a liquid.
